(19) United States
(12) Patent Application Publication
(10) Pub. No.: US 2004/0258821 A1
(43) Pub. Date: Dec. 23, 2004

(54) Filtration of dipeptide and dipeptide derivative sweeteners

(76) Inventor: Justin L. DePauw, Moncure, NC (US)

Correspondence Address: Jeffrey M. Hoster, 200 World Trade Center, Suite 936, Merchandise Mart, Chicago, IL, 60654, US

(21) Appl. No.: 10/825,875

(22) Filed: Apr. 16, 2004

Related U.S. Application Data
(60) Provisional application No. 60/463,578, filed on Apr. 17, 2003.

(51) Int. Cl. A23L 1/236

(52) U.S. Cl. 426/548

(57) ABSTRACT

An improved process for the filtration of sweeteners such as aspartame is disclosed. In the process, a filter unit equipped with filter elements such as sintered metal filter elements is used to purify a slurry of sweeteners such as aspartame or neotame by separating the crystals from liquid. The slurry is purified by use of cold deionized water and pressurized air, which forces impurities then the liquid out of the filter unit so that crystals of sweeteners remain in the unit. These crystals are then dehydrated, with the resulting crystals collected.

This application claims the priority of U.S. Provisional Application Ser. No. 60/463,578, filed on Apr. 17, 2003.

### BACKGROUND OF THE INVENTION

This invention relates to the field of manufacturing high intensity sweeteners which are dipeptide sweeteners or derivatives of dipeptide sweeteners. More particularly, this invention relates to the field of the manufacture of sweeteners such as aspartame or neotame by use of manufacturing processes in which the purification of crystals of the sweeteners is required.

Aspartame (α-L-aspartyl-L-phenylalanine methyl ester) is a dipeptide sweetener that is commercially sold worldwide. It is commonly manufactured using processes in which a protected aspartic acid is coupled with either L-phenylalanine or L-phenylalanine methyl ester. The resulting coupled product is then deprotected and neutralized prior to crystallization of the aspartame.

The crystallized aspartame must be purified to remove both impurities produced during the process and reactants, solvents and other process additives. Conventional purification methods include pressure filtration, vacuum filtration, centrifugation, and chromatography. However, there are flaws with each of these methods in terms of cost, inability to remove all desired components, or ineffectiveness at scale.

Neotame (N-[N-(3,3-dimethylbutyl)-L-α-aspartyl]-L-phenylalanine 1-methyl ester) is a dipeptide sweetener derivative produced by the coupling of aspartame with 3,3-dimethylbutyraldehyde. The resulting product has a potency of about 8,000 times the potency of sucrose. This can be compared to the potency of aspartame, which is about 200 times the potency of sucrose. The product of the coupling reaction, following crystallization, requires purification similar to that of aspartame. The above described conventional purification methods have similar flaws when applied to neotame.

Therefore, there is a need for a method and equipment to purify the crystallization products of dipeptide and dipeptide derivative sweeteners. It is an object of the present invention to provide such a method and equipment.

### SUMMARY OF THE INVENTION

The present invention details a purification process for dipeptide sweeteners such as aspartame, as well as dipeptide sweetener derivatives such as neotame. In the inventive process, prior to purification, the sweetener is produced in slurry form and is comprised of unpurified crystals. The sweetener is fed to a filter unit comprising filter elements which are manufactured of sintered metal or porous ceramic. The unpurified sweetener is fed through the filter unit via a series of valves, which are also used to add air or water. The sweetener is purified by feeding the slurry to the filter elements with sufficient pressure to enable the liquid portion to pass through the elements, leaving the solids on the filter. Additional steps are involved in maximizing the effectiveness of the process; for example, water washes are used to remove impurities. After purification, the sweetener is discharged from the unit by use of air pressure, and is ready for subsequent drying and packaging steps.

### DETAILED DESCRIPTION OF THE PREFERRED EMBODIMENT

In a preferred embodiment of the present invention, aspartame and neotame crystals can be purified by use of equipment comprising sintered metal filter elements or porous ceramic filters.

The preferred process utilizes equipment such as a filter unit commercially available from Mott Corporation. A particularly desirable filter unit is one sized from twenty inches to three feet in diameter and five to eight feet in height. This filter unit is equipped with one or more sintered metal filter elements. Particularly desirable elements are two-inch to four-inch in diameter, thirty to fifty inches tall, and possess a 0.55 to 15-micron pore size. The optimum element has been found to be an element 3 inches in diameter, 40 inches long, and possessing a pore size of 5 microns. These filter elements are made by a variety of methods. In one particular method, powdered metal is heated into sheets. The powder is fused together at points of contact, resulting in an element where void spaces remain. The sheets are then rolled and welded into tubular filter elements, which are used in the filter unit. Such tubular filter elements must be strong enough to resist the pressures applied to them by the system. Each filter unit will include at least one, and may include multiple, tubular filter elements. Each unit will also include multiple valves and nozzles which are used 1) to feed slurry containing crystals of dipeptide sweetener or derivative, such as aspartame or neotame, into the elements, 2) to add air pressure to the unit, 3) to drain liquid from the unit, 4) to add wash water to the unit, and 5) to discharge the filter cake including the purified crystals.

The product to be purified is fed through the elements via the process described below. A slurry containing crystals of aspartame or neotame is fed to the inside of the tubular filter elements. This slurry can be from about 0.1 to 10% product by weight, more preferably 5 to 6% product by weight. The temperature of the slurry may be from about 2-12 degrees C., more preferably 4-8 degrees C. This feed typically occurs via a valve located at the bottom (heel) of the filter unit. The unit also may contain a liquid drain valve, which remains open during the feed step. The slurry is forced upward into the inside of the tubular filter element(s), preferably at a rate of 0.5 to 5 liters per minute per square foot of element surface, most preferably at about 3 liters per minute per square foot of element surface. The liquid portion of the slurry is forced out through the pores and allowed to drain freely from the shell of the unit through a nozzle in the tube sheet or side of the shell, leaving the solids remaining on the inside of the filter element. Feeding of the slurry continues until a targeted quantity of crystals has been retained in the filter elements. The retention quantity is approximately 200-500 grams of crystals per square foot of filter element surface.

After feeding of the slurry ends, air is supplied to the heel of the unit to push any remaining slurry into the filter element and to remove additional water and impurities from the cake remaining on the inside of the filter element. The air rate during this process is in the range of about 1.5 to 15 standard cubic feet per minute per square foot of element, more preferably in excess of 4 standard cubic feet per minute (scfm) per square foot of element for a period of at least one minute. Higher flows and differential pressures may increase the dewatering effectiveness; however, excessive pressures may cause excessive compaction of the solid cake. This can result in difficulty in the discharge of the cake. During the dewatering step, unfiltered liquid is drained from the heel of the unit through the feed line or an alternate line at the bottom of the unit. Sequencing of these valves during this step must be coordinated to prevent disturbing the cake on the inside of the elements.

Following the drainage of liquid, compaction of the cake is important. The compaction can be accomplished by the addition of water followed by pressurized air. In one method, a wash using cold water may be applied. The cold water may be added to the heel of the unit so the water flows from the inside of the element, through the product cake, and then out through the element walls into the shell. The wash water is then drained in the same manner as the previous drainage of feed liquid. It is preferable to wash the cake with about 1.3 liters of cold water per square foot of element surface area at about 3.5 lpm/ft2. Follow the wash immediately with compressed air at a rate of about 7 scfm per square foot of element surface for at least five minutes. The force of the water and air being added to the unit and removed through the filter compacts the cake to a desirable consistency. The water also aids in removing impurities from the product cake. The resulting compacted cake has better drying, washing, and removal characteristics. The solid cake is then further dehydrated by use of heated air. Increasing the air temperature will result in the product cake dehydrating faster. However, excessive temperatures can cause undesirable degradation or alteration of the product crystal. The air used in this step may be in the range of 32-150° C., and more preferably in the range of 100 to 120° C. The material is preferably dehydrated to a moisture level of 25-35% by weight, but can be dehydrated to lower moisture contents if desired.

Following dehydration, the solid cake is ready to be removed from the unit. All valves are closed. The filter unit is then pressurized, preferably from the bottom feed valve, and preferably to a pressure in the range of 30-100 psi, and most preferably to a pressure in the range of 65-75 psi. Once pressurized, the bottom discharge valve is quickly opened. The air in the shell of the unit then flows into the filter element(s), forcing the product cake off of the element walls and out of the filter unit. The volume of the filter housing outside the elements should be at least 2.5 times the combined internal volume of the elements to ensure complete cake discharge. This ratio may vary depending on the size and geometry of the housing.

This method of purification offers greater flexibility than currently employed methods. For example, one common form of crystallizing aspartame is the use of a static crystallization technique as described in U.S. Pat. Nos. 5,041,607 and 5,097,060. This technique is often used so that crystals have specific particle size ranges to ensure subsequent purification steps are effective. In particular, it is often difficult to purify small crystals of aspartame, which can result from non-static crystallization processes. However, it has been found that the present inventive process can effectively be used with such particles. In particular, the inventive process exhibits surprising functionality with crystals as small as five microns.

The aspartame product resulting from the inventive purification process has exceptional purity (residue on ignition values in the final product are less than 0.05% by weight). Moisture levels can be reduced to very low levels; for example, moisture levels of less than 5% can easily be obtained without adverse effects that may be found in other purification processes. This compares to centrifuge purifications in which reduction in moisture below 35% is difficult. There are also operational benefits resulting from the inventive process. In particular, the system has reduced maintenance and operational problems, as it relies on simple mechanical principles, and can be operated as a fully automated system. Unlike conventional purification processes, the system is self-cleaning as it is a sealed system that can be cleaned as desired by flooding.

The following examples provide further detail as to operation of the inventive process.

### EXAMPLE 1

A Mott Corp. Hypulse Filter, model #8604009, SN:B027, single element unit 4″ (“Filter Unit”) in diameter was used for the trial. The element in the unit was 30″ tall, 3″ in diameter, and rated at 2 microns. A 55-gram per liter slurry of APM at about six degrees Celsius was supplied to the Filter Unit.

The trial began by opening the top shell and feed nozzles of the Filter Unit to feed slurry into the heel (bottom) of the Filter Unit, through the elements, and out of the shell (top). This built a layer of product on the inside of the filter elements. About 8 liters of slurry was fed to the element in about 38 seconds. This achieved to a differential pressure across the element of about twenty pounds per square inch (psi). When the feed valve was closed, air was supplied to the heel of the filter at about 75 psi. This blows the majority of the remaining liquid portion of the slurry out of the element. The bottom shell nozzle was then opened and the top shell nozzle closed, to drain all the filtrate from the shell. Air continued to be added to the heel of the unit for 7.5 minutes to further drive liquid out of the cake. At this point the cake is about 1 to 1¼ inches thick and very fluffy.

Cold DI water was then added to the heel with the top shell nozzle open. The water flows through the product cake to displace (wash out) the remaining slurry liquid and the contaminants within it. Two liters of cold DI water was feed to the unit in about 10 seconds. When the cold water valve was closed, air was supplied to the heel of the filter at about 70 psi. The bottom shell nozzle was then opened and the top shell nozzle closed, to drain all the liquid from the shell. Air continued to be added to the heel of the unit for 7 minutes to further drive liquid out of the cake. At this point the product cake in the element is 1/4 inch thick. The cold water wash compresses the product cake.

Hot air was then supplied to the heel of the filter unit at about 30 psi for 15 minutes. The top and bottom shell nozzles were open to vent this air. All valves on the filter were closed at the end of the 15 minute hot air feed. The filter was then pressurized to 60 psi. The bottom discharge valve was then opened quickly. This drove the dried product out of the element and into a bag secured below the discharge valve. All the product in the element was removed. After lab analysis, the product contained 23.5% (% by weight) moisture and 0.1% residue on ignition (salt). The conductivity of the material was 31.44 micro siemens per centimeter.

### EXAMPLE 2

A Mott Corp. Hypulse Filter, model #8604009, SN:B027, single element unit 4″ (“Filter Unit”) in diameter was used for the trial. The element in the unit was 40″ tall, 3″ in diameter, and rated at 5-microns. A 55-gram per liter slurry of APM at about six degrees Celsius was supplied to the Filter Unit.

The trial began by opening the top shell vent, shell body drain, and feed valves of the Filter Unit to feed slurry into the heel (bottom) of the Filter Unit, through the element, and out of the shell body drain. 16 liters of slurry was fed to the element in about two minutes. This built about 1 to 1¼ inch thick, very fluffy layer of product on the inside of the filter element. About 11 scfm of compressed air was injected just below the element support plate for one minute immediately upon termination of the feed. This blew the remaining liquid portion of the slurry through the element and out the body drain. During this dewatering period the heel drain was opened to discharge the unfiltered slurry remaining in the heel of the filter.

After filling the heel chamber, 3½ liters of cold deionized water was forced through the product cake and filter element to the shell body drain at a rate of 11 liters per minute. This water displaces the remaining slurry liquid and the contaminants within it. Immediately upon termination of the water feed, about 18 scfm of compressed air was injected just below the element support plate for five minutes. This blew the remaining wash water rapidly through the element and out the body drain. The extended air blow down mechanically forces the bulk of the remaining water out of the void spaces between the product crystals. The combination of the cold water wash and the blow down cycle crushed the product cake to about ½″ thick. During this dewatering period, the heel drain was opened to discharge the water remaining in the heel of the filter.

About 10.5 scfm of air, heated to 110 degrees Celsius, was then supplied to the heel of the filter unit for about 15 minutes. The air passed through the product cake and filter element and vented through the shell vent and drain nozzles. This hot air evaporated enough of the water remaining on the product crystal to yield a cake with a moisture content of less then 30%. This product showed it contained less than 0.1% residue on ignition (salt) and had a conductivity of about 30 micro siemens per centimeter. The shell vent and drain valves were closed at the end of the hot air drying cycle, allowing the filter to pressurize to 60 psi. The bottom discharge valve was then opened quickly. This drove the dried product out of the element and into a receiver tank immediately below the discharge valve. This discharge cycle was repeated three times to ensure all the product in the element was discharged.

The inventive process has functionality in the manufacture of sweeteners including aspartame and neotame. It is expected to have functionality in other dipeptide derivative sweeteners, including but not limited to those described in U.S. Pat. Nos. 5,723,165, 5,795,612, 5,958,496, 6,010,733, and 6,548,096, each of which is incorporated by reference herein.

What is claimed is:

1. A process for purification of dipeptide sweeteners and dipeptide derivative sweeteners, comprising the steps of:
(a) feeding a slurry comprising dipeptide sweetener or dipeptide derivative sweetener crystals to a filter unit comprising at least one filter element selected from the group comprising sintered metal filter elements and porous ceramic filter elements, said slurry being fed to the inside of said filter element;
(b) providing sufficient pressure to said filter unit to force liquid from said slurry through said filter element;
(c) removing said liquid from said filter unit;
(d) recovering the remaining portion of said slurry, comprising crystals of said dipeptide sweetener or dipeptide derivative sweetener.

2. The process of claim 1 wherein said sintered metal filter element is from two-inches to four-inches in diameter and thirty to fifty inches tall.

3. The process of claim 1 wherein said sintered metal filter element has a pore size of about 0.5-15 microns.

4. The process of claim 1 wherein said slurry comprises 0.1 to 10% aspartame by weight.

5. The process of claim 4 wherein said slurry comprises 5 to 6% aspartame by weight.

6. The process of claim 1 wherein said slurry is fed to the inside of the filter element via a valve located at the bottom of said filter unit.

7. The process of claim 1 wherein said pressure in step (b) is in the range of 5 to 120 psi.

8. The process of claim 7 wherein said pressure in step (b) is in the range of 40 to 80 psi.

9. The process of claim 1 comprising the additional step between steps (c) and (d):
supplying pressurized air to the bottom of said filter unit, said pressurized air being vented from the top of said filter unit to remove additional water from said filter unit.

10. A process for purification of dipeptide sweeteners and dipeptide derivative sweeteners, comprising the steps of:
(a) feeding a slurry comprising dipeptide sweetener or dipeptide derivative sweetener crystals to a filter unit comprising at least one filter element selected from the group comprising sintered metal filter elements and porous ceramic filter elements, said slurry being fed to the inside of said filter element;
(b) providing sufficient flow rate to said filter unit to force liquid from said slurry through said filter element;
(c) supplying pressurized air to the bottom of said filter unit, said pressurized air being vented from the vent and body drain of said filter unit to remove additional water from said filter unit to form a solid cake comprising crystals of dipeptide or dipeptide derivative sweetener;
(d) supplying cold water to the bottom of said filter unit, said water passing through said cake and filter element and being discharged from said filter body drain, resulting in the removal of impurities from said solid cake;
(e) forcing pressurized water followed by pressurized air through said cake for the purpose of compacting and removing excess water from said cake;
(f) forcing heated air through said cake for the purpose of dehydrating said compacted cake;
(g) discharging said dehydrated compacted cake by pressurizing said filter unit and opening a valve in said unit.

11. The process of claim 10 wherein said sintered metal filter element is from about two inches to four inches in diameter and thirty to fifty inches in height.

12. The process of claim 10 wherein said sintered metal filter element has a pore size of about 0.5-15 microns.

13. The process of claim 1 wherein said slurry comprises 0.1 to 10% aspartame by weight.

14. The process of claim 4 wherein said slurry comprises 5 to 6% aspartame by weight.

15. The process of claim 1 wherein said slurry is fed to the inside of the filter element via a valve located at the bottom of said filter unit.

16. The process of claim 1 wherein the flow rate in step (b) is about 0.5 to 5 liters per minute per square foot of element surface.

17. The process of claim 16 wherein said flow rate in step (b) is about 3 liters per minute per square foot of element surface.

18. The process of claim 10 wherein said flow rate of said cold water in step (d) is about 3.5 liters per minute per square foot of element surface.

19. The process of claim 10 wherein said flow rate of said compressed air in step (e) is in excess of 7 standard cubic feet per minute per square foot of element for a period of at least one minute.

20. The process of claim 10 wherein the volume of pressurized water in step (e) is about 0.3 to 5 liters per square foot of element surface.

21. The process of claim 20 wherein said volume of pressurized water in step (e) is about 2 liters per minute per square foot of element surface.

22. The process of claim 21 wherein said volume of pressurized water in step (e) is applied for at least 30 seconds.

23. The process of claim 10 wherein the volume of pressurized air in steps (e) and (f) is about 1.5 to 15 standard cubic feet per minute per square foot of element.

24. The process of claim 23 wherein said volume of pressurized air in steps (e) and (f) is about 7 standard cubic feet per minute per square foot of element.

25. The process of claim 24 wherein said volume of pressurized air in steps (e) and (f) is applied for at least five minutes.

26. The process of claim 24 wherein said pressurized air is applied until said cake has a moisture level of between 20-35% by weight.

27. The process of claim 10 wherein the air applied in step (f) is in the range of 32-150° C.

28. The process of claim 10 wherein step (f) is carried out under heat conditions whereby the air temperature in said element is between 230-260° C.

29. The process of claim 10 wherein step (g) wherein said filter unit is pressurized to a pressure of between about 30-100 psi.
